(19) United States
(12) Patent Application Publication
(10) Pub. No.: US 2017/0024674 A1
(43) Pub. Date: Jan. 26, 2017

(54) SYSTEM FOR PROVISIONING BUSINESS INTELLIGENCE

(71) Applicant: Woolton Inc., Miami, FL (US)

(72) Inventors: Carlos Lerena, Miami, FL (US); Gonzalo Almada, Miami, FL (US); William Osteux, Miami, FL (US)

(21) Appl. No.: 15/093,979

(22) Filed: Apr. 8, 2016

Related U.S. Application Data
(60) Provisional application No. 62/145,658, filed on Apr. 10, 2015.

(51) Int. Cl. G06Q 10/06; G06Q 10/04

(52) U.S. Cl. CPC G06Q 10/06393; G06Q 10/04; G06Q 10/06313

(57) ABSTRACT

Disclosed is a method of provisioning business intelligence to a plurality of users in a business organization. The method may include storing a plurality of business analytical data corresponding to a level of a plurality of levels in the business organization. Further, the method may include generating a user interface including a plurality of visualizations of the plurality of business analytical data. Additionally, the method may include communicating the user interface to a plurality of user devices associated with a plurality of users. Accordingly, the plurality of devices may be configured to display the user interface.

### RELATED APPLICATION(S)

Under provisions of 35 U.S.C. §119(e), the Applicant claims the benefit of U.S. provisional application No. 62/145,658, filed Apr. 10, 2015, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

It should be noted that a plurality of appendices are attached to the provisional application from which this present application claims priority. The appendices disclose a plurality of embodiments, as well user interface and functions associated therewith. Such embodiments are herein incorporated into the present disclosure as part of the detailed description below. Applicant reserves all right to expressly incorporate the disclosure of the appendices in the present application or any future patent application filed claiming priority to the present application.

The appendices disclose specific interfaces, user flows, functions, features, preferences, and limitations. Although these illustrated aspects are disclosed in a particular order with particular functions and limitations, it should be understood that the order and limitations are disclosed for illustrative purposes only. Elements may be combined, separated, reordered, and various intermediary stages may exist. Accordingly, it should be understood that the various stages illustrated within the appendices may be, in various embodiments, performed in arrangements that differ from the ones illustrated. Moreover, various elements may be added or removed from the flow charts without altering or deterring from the fundamental scope of the depicted methods and systems disclosed herein.

### FIELD OF DISCLOSURE

The present disclosure generally relates to virtualizing business analytics in a networking environment.

### BACKGROUND

Organizations generally maintain and analyze data associated with the organization in order to function well. For instance, most businesses gather and analyze data related to operations to generate business analytic data. As an example, a clothing store may track its sales and inventory to find which products move more quickly and less quickly than others. Such data may be indicative of, for example, performance of a business. Further, business analytic data may be presented to users associated with the organization, such as for example, managers and staff members. For instance, graphs and/or charts may be presented to the users to indicate performance of different business units.

However, in cases of large business organizations, the amount of business analytical data generated may be huge. For example, an international retail organization may have several business units across the globe regularly generating large quantities of business analytical data. Accordingly, users may be overwhelmed by the amount of business intelligence presented to them. Further, some users may be presented with business analytical data which may not be relevant to their role and/or responsibility.

Additionally, the user interface of existing methods and systems of provisioning business intelligence is cumbersome and/or unfriendly to users due to the large amount of information being presented. For instance, a non-intuitive user interface may cause users to face inconvenience in navigating through business analytical data associated with various levels and/or units of a business.

Moreover, users now use a variety of devices such as laptop computers, desktop computers, smartphones and tablet computers. However, the existing user interfaces are designed to be compatible with a limited number of device types.

Further, in cases where an organization is structured hierarchically, there are several scenarios where business analytical data may need to be limited to one or more predetermined levels within the hierarchy. For instance, business analytical data may need to be selectively presented to users based on their access rights and privileges.

Moreover, there may be scenarios where users may be more interested in business analytical data associated with a business unit than others. However, existing methods and systems do not allow users to conveniently indicate a preference of receiving certain business analytical data with a higher priority. Accordingly, users may be inconvenienced to sift through large amounts of data that are provided to them in order to locate and consume business analytical data of interest.

Additionally, existing methods and systems of provisioning business intelligence provides very limited interaction with users. Such interaction is usually limited to users being able to view the business analytical data, save them for future reference and/or share them with other users over a separate communication channel such as, for example, email. Moreover, there is no provision for users to request and/or provide additional data to supplement the business analytical data. Further, any discussion on the business analytical data between users currently takes place offline, such as in meetings, and/or over emails. Moreover, any further actions such as requesting for additional data or providing additional data with regard to a business analytical data takes place in dissociation with the original business analytical data. In other words, such actions are currently dissociated from the corresponding business analytical data.

Since interaction of users with business analytical data in itself forms an important part of business intelligence, provisioning of such information in a user friendly manner is desirable. However, due to the dissociation between business analytical data and user interactions related to the business analytical data, existing methods and methods are ill equipped to provide comprehensive business intelligence information to users that includes user interaction data.

Accordingly, there is a need for improved methods and systems for provisioning business intelligence to users of a business organization.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present disclosure provide a Business Intelligence (BI) networking platform (hereinafter also referred to as “BI platform”). A BI platform consistent with embodiments of the present disclosure may virtualize the provision of business analytical data such as, but not limited to, for example, Key Performance Indicator (KPI) data to a plurality of interested users. Users of the BI platform may access the BI platform through a plurality of mediums, comprised of, but not limited to, a web-app, desktop, or mobile device application. The user's interface and functionality with the BI platform may be based on a defined role.

A BI platform role for the user may define the user's permissions and privileges which may, in turn, correspond to a user interface and functionality provided to the user. In this way, a business CEO may be provided with a first set of platform functionality while a Store Manager may be provided with a second set of platform functionality. In various embodiments, the first set of functionality provided to the ‘CEO’ may encompass the second set of functionality provided to a ‘Store Manager’, thereby establishing a hierarchal access system to the BI platform.

As mentioned above, BI may be comprised of a plurality of business analytical data including, but not be limited to, KPIs that are tracked, analyzed and displayed to a BI platform user. Accordingly, and still consistent with embodiments of the present disclosure, BI platform may enable a BI platform user to perform a plurality of functions to the provided analytical data including, but not limited to, promotion (e.g., favoring, promoting, or ‘Liking’), discussing (e.g., replying, noting, or ‘Commenting’), sharing (e.g., emailing, messaging, or ‘Re-Posting’), and reporting (e.g., detailed analysis). Further, the BI platform also allows users to upload information, data and different elements such as pictures, answers to questions, feedbacks, completed forms, etc.

The extent to which such functionality may enable an interaction from one BI platform user to another BI platform may be based on each corresponding user's platform privileges and permissions. In other words, and as will be detailed below, functions performed by a ‘CEO’ may be visible and/or shared with all roles below the ‘CEO’ (e.g., a ‘Regional Manager’) but not all actions taken by a ‘Regional Manager’ may be visible and/or shared with roles above the ‘Regional Manager’ (e.g., a ‘CEO’). In this fashion, information is compartmentalized and shared only with parties to whom the data is relevant.

In yet further embodiments of the present disclosure, various user interfaces may be provided to facilitate the interaction and functionality with the BI platform.

Additionally, in various embodiments, the user interface provided to users may be user friendly. Accordingly, users may be able to navigate through a plurality of visualizations corresponding to a plurality of business analytical data, such as, for example, KPIs using intuitive gestures. For instance, users may be able to transition between visualizations corresponding to different KPIs by performing horizontal swipe actions on a touch based user interface. Similarly, users may be able to transition between visualizations corresponding to KPIs of different levels within a business organization by performing vertical swipe actions.

Further, in various embodiments, actions performed by users on a visualization may generate notifications to other users. For example, when a country level manager performs an action such as, for example, a “like” action on a visualization of quarterly sales of a district, notifications may be generated and sent to users associated with business units within the district. Further, in some embodiments, such notifications may only propagate to users down the hierarchy. For instance, a notification may not be sent to users who are above the country level manager in organizational hierarchy. However, in some embodiments, an action performed on a global analytical data by a CEO and/or a CFO may be propagated to all users in the business organization. Accordingly, a user may be identified for sending of notifications related to actions performed on a visualization of business analytical data based on a level associated with the business analytical data and/or a role of the user.

Furthermore, in various embodiments, the user interface may be configured to allow users to set alerts on a visualization of business analytical data. The user interface may allow the user to specify the business analytical data, such as the KPI, to be monitored. Further, the user interface may include a drop down menu allowing the user to specify a condition for triggering the alert. The drop down menu may include options such as, for example, “when KPI falls below” or “when KPI rises above”. Further, the user interface may also allow the user to specify a limit, such as a numerical limit as part of the trigger condition. Consequently, when the KPI meets the trigger condition specified by the user, an alert may be generated and sent to the user.

Accordingly, the BI platform has the ability to communicate and integrate the whole business organization through KPI's, reports, content and data. Further, the provisioning of business intelligence not only communicates a result from the business organization to an employee, it also empowers the employees to discuss those results with their colleagues, team, etc.

Further disclosed is a method of provisioning business intelligence to a plurality of users in a business organization. The method may include creating a plurality of user accounts corresponding to the plurality of users. Further, the method may include assigning a role to each user of the plurality of users. Accordingly, a role assigned to a user may be associated with a user account of the user. Additionally, the method may include displaying a user interface to a user of the plurality of users based on a role assigned to the user. Further, the user interface may include a representation of a hierarchy of the business organization. In some instances, the hierarchy may include a plurality of levels. For instance, the plurality of levels may include at least two of global, regional, country, state, district, store and staff.

Additionally, the user interface may also include a plurality of dashboards corresponding to the plurality of levels. Further, each dashboard may include one or more KPIs. Furthermore, the user interface may be configured to receive a user input from the user in order to enable the user to navigate through the plurality of dashboards.

Accordingly, in some embodiments, the user input may be directed to one or more of the representation of the hierarchy and the plurality of dashboards. For instance, the user input may be a touch input received over a portion of a touch screen displaying the hierarchy. Similarly, in another instance, the touch input may be received over a portion of the touch screen displaying a dashboard of the plurality of dashboards.

Further, in some embodiments, the user interface may be configured to transition between displaying a first dashboard corresponding to a first level and displaying a second dashboard corresponding to a second level. Further, the transition may be based on the user input. For example, the user interface may be configured to receive a vertical swipe on a touch screen and accordingly transition between displaying a dashboard corresponding to district level and displaying a dashboard corresponding to country level. Accordingly, in some embodiments, based on an intuitive gesture such as an upward swipe or a downward swipe the user may be enabled to navigate across the plurality of dashboards across the multiple levels of the hierarchy.

Additionally, in some embodiments, the user interface may be configured to transition between displaying a first dashboard including the one or more KPIs associated with a plurality of entities and displaying a second dashboard including a ranking of the plurality of entities. Further, the ranking may be based on values of the one or more KPIs associated with the plurality of entities.

Further, the method may include providing a functionality associated with the user interface to the user. The functionality may enable the user to perform one or more actions. Further, the functionality may be based on the role assigned to the user. Accordingly, in some embodiments, the one or more actions may include one or more of promoting, discussing, sharing, uploading a report, requesting a report and a setting an alert. Accordingly, in some embodiments, the method may further include receiving a report from one or more users of the plurality of users. Further, the report may include business analytical data corresponding to the one or more KPIs.

Additionally, the method may include displaying interaction data corresponding to the functionality to a user. Further, the displaying may be based on the role assigned to the user.

Further, in some embodiments, the user interface may be further configured to display a notification to a user based on receipt of the one or more actions. Additionally, the display of the notification may be further based on one or more of a level of business analytical data associated with a dashboard and a role assigned to the user.

Furthermore, in some embodiments, setting the alert may include specifying one or more of a lower limit and an upper limit. Further, the user interface may be further configured to display the notification based on a result of comparison of a business analytical data associated with a dashboard with one or more of the lower limit and the upper limit.

Moreover, in some embodiments, the method may further include aggregating the interaction data corresponding to the plurality of users. Accordingly, the user interface may be configured to display a community view of the interaction data based on the aggregating.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates an embodiment of a business intelligence networking platform;

FIG. 2 is a flow chart of a method for providing a business intelligence networking platform;

FIG. 3 illustrates a structure for platform administrator access;

FIG. 4 illustrates an embodiment of a hierarchy that may determine user access;

FIG. 5 illustrates an embodiment of split-screen scrolling;

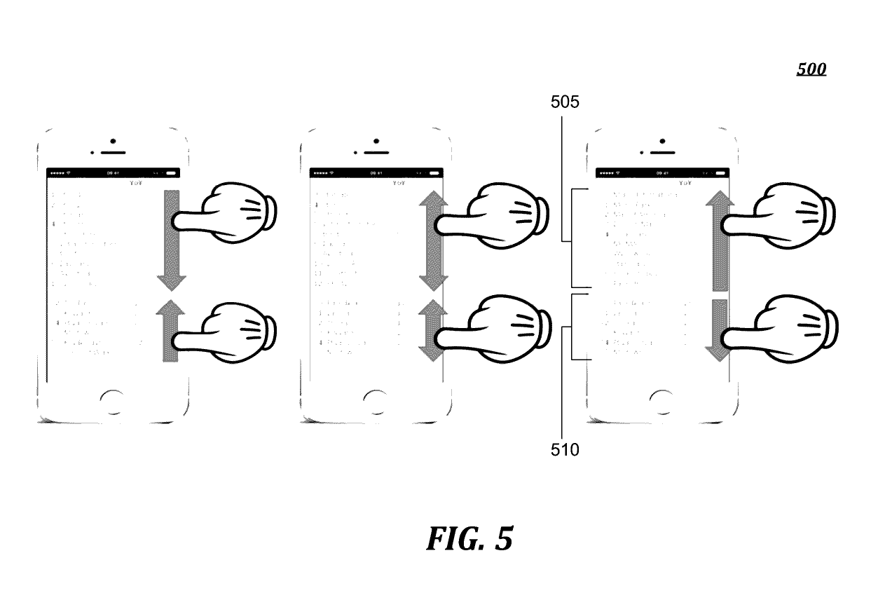

FIG. 6 illustrates embodiments of a plurality of displays of business analytical data a potential way in which users may transition between the plurality of displays;

FIG. 7 illustrates an embodiment of platform operation;

FIG. 8 illustrates a user interface for provisioning business intelligence depicting various levels of a business organization associated with business analytical data in accordance with some embodiments;

FIG. 9 illustrates a user interface for provisioning business intelligence depicting visualization of business analytical data such as KPIs and GUI elements for enabling interaction with the visualization in accordance with some embodiments;

FIG. 10A illustrates a user interface for provisioning business intelligence depicting a GUI element for setting an alert on a KPI in accordance with some embodiments;

FIG. 10B illustrates a user interface for provisioning business intelligence depicting GUI elements for specifying trigger conditions for setting an alert on a KPI in accordance with some embodiments;

FIG. 10C illustrates a user interface for provisioning business intelligence depicting exemplary values of trigger conditions for setting an alert on a KPI in accordance with some embodiments;

FIG. 10D illustrates a user interface for provisioning business intelligence depicting a visual indicator informing receipt of an alert on a KPI in accordance with some embodiments;

FIG. 10E illustrates a user interface for provisioning business intelligence depicting a scenario in which an alert on a KPI in not set and not triggered, in accordance with some embodiments.

FIG. 10F illustrates a user interface for provisioning business intelligence depicting a scenario in which an alert on a KPI in set but is not triggered and another scenario in which the alert is set and is triggered, in accordance with some embodiments.

FIG. 11 illustrates a user interface for provisioning business intelligence depicting a notification of a user action on a visualization of business analytical data in accordance with some embodiments;

FIG. 12A illustrates a user interface for provisioning business intelligence depicting a GUI element for enabling a user to mark a visualization as a favorite in accordance with some embodiments;

FIG. 12B illustrates a user interface for provisioning business intelligence depicting a list of visualizations of business analytical data marked as favorite by a user in accordance with some embodiments;

FIG. 13 illustrates a user interface for provisioning business intelligence depicting display of KPIs and associated entities in a table sorted according to increasing or decreasing order;

FIG. 14 is a block diagram of a system including a computing device for performing the method of FIG. 2; and

FIG. 15 illustrates an organizational hierarchy based on which business analytical data is provisioned to users according to various embodiments;

FIG. 16 illustrates a user interface for provisioning business intelligence depicting a notification of a KPI shared by a user with another user, in accordance with some embodiments.

FIG. 17A illustrates a user interface for provisioning business intelligence configured for receiving forecast data from a user, in accordance with some embodiments;

FIG. 17B illustrates a user interface for provisioning business intelligence configured for displaying the forecast data to users, in accordance with some embodiments;

FIG. 18 illustrates a flow chart of a method of receiving forecast data from a user, in accordance with some embodiments.

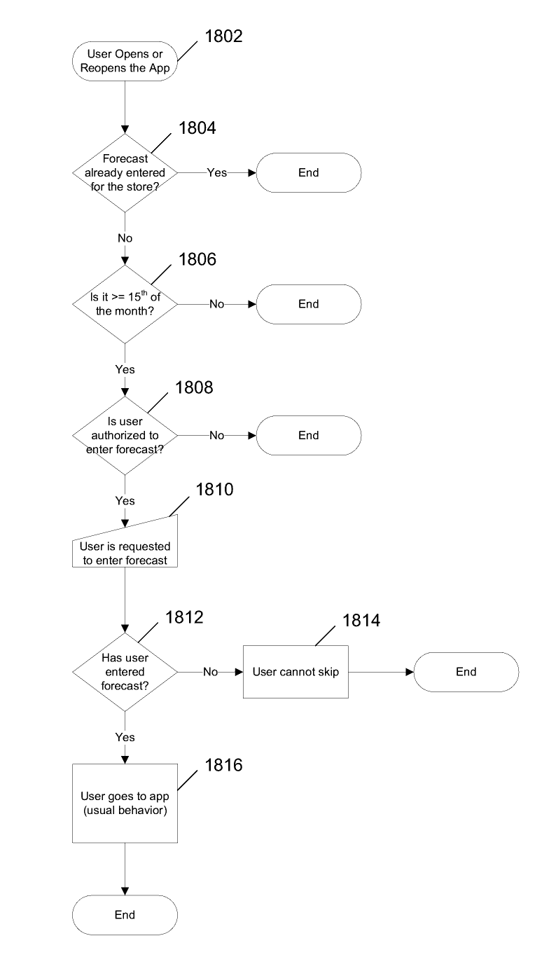

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of retail business, embodiments of the present disclosure are not limited to use only in this context.

### I. Platform Overview

Consistent with embodiments of the present disclosure, a business intelligence networking platform may be provided. This overview is provided to introduce a selection of concepts in a simplified form that are further described below. This overview is not intended to identify key features or essential features of the claimed subject matter. Nor is this overview intended to be used to limit the claimed subject matter's scope.

The business intelligence networking platform may be used by individuals or companies to organize and communicate relevant information and, also, to gather relevant information from the market (users) like forecast, answer to questions, relevant forms, feedbacks, etc. Although the presented embodiments reference the retail industry, it should be understood that the retail industry is used as an example and that the embodiments may be applicable across business industries. Embodiments of the present disclosure may utilize pre-programmed Key Performance Indicators (KPIs) as well as user-provided KPIs. Although the present embodiments reference KPIs, it should be understood that KPIs are used as an example and that the embodiments may be applicable to various other forms of business intelligence and analytical data.

Accordingly, as will be disclosed herein for providing an example scenario of the presented embodiments, a BI platform disclosed herein may be configured to provide users with on-time analytics for retail environments. Further, embodiments may provide users with data visualization for users, across the organizations, from Store Managers to CEOs.

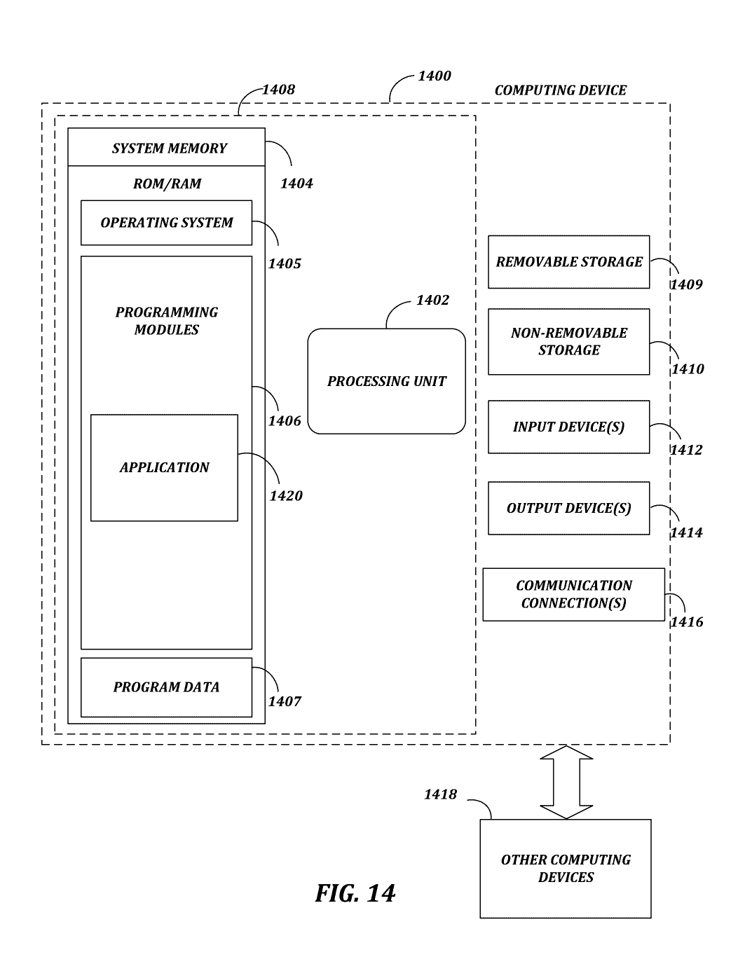

Embodiments of the BI platform may comprise a software application coupled with a computing system (e.g., a server). The application may be accessible through any suitable computing device, as detailed with reference to FIG. 14. However, the BI platform may be optimized for access by mobile computing device users (e.g., phone, tablet, laptop, and generally portable display users). In this way, the BI platform may be optimized to provide KPIs (or other business analytical data) to on-the-go to users, such as, for example, C-level Managers, Regional Directors, Country Manager, Districts Manager, Store Managers and Sales Representatives. This solves the problem of having each user access a static software application tied to a particular device or on premise location.

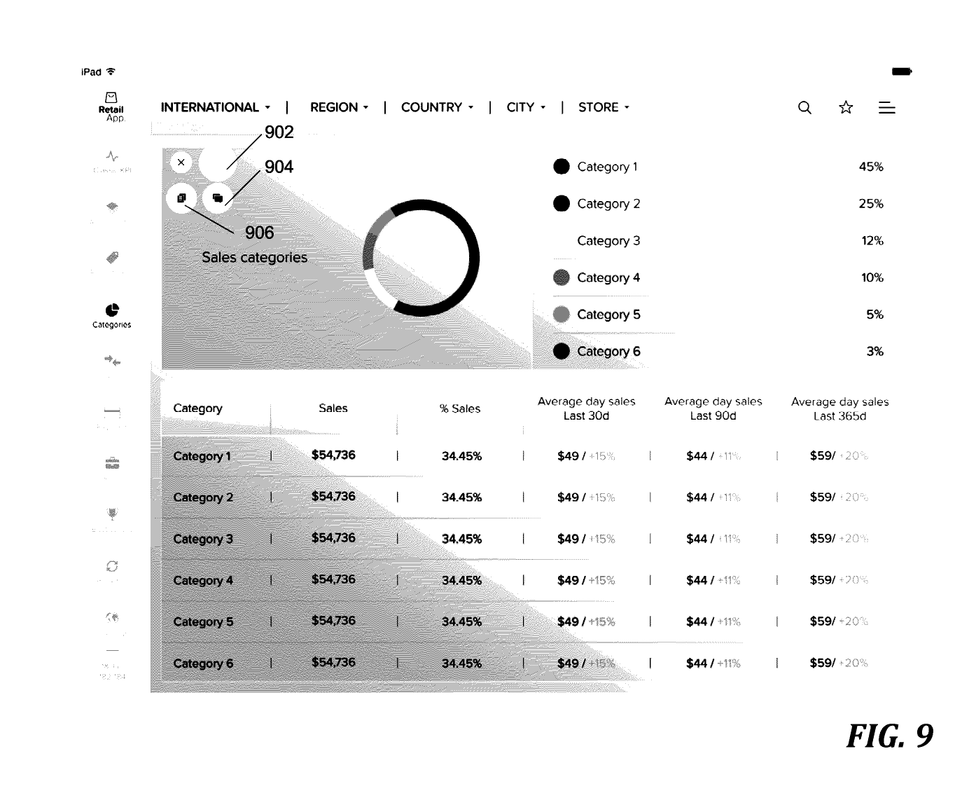

A user may be provided with a dashboard view of the analytical data. Various user interfaces associated with the dashboard view may be provided as exemplarily illustrated in FIG. 9. For instance, each Region may be associated with a plurality of KPI dashboards. Accordingly, the user may be enabled to scan multiple Regions by swiping through the dashboard screen. Accordingly, the same KPI dashboard across different Regions may be displayed to the user.

Within these dashboards, a user may be enabled to not only view the analytical data to which the user is privileged and permitted, but engage in networking interaction to which the user is privileged and permitted. For example, the user interface may include a GUI element 902 may enable the user to indicate a “Like” on the visualization of the business analytical data, such as the KPI. Similarly, the user interface may include a GUI element 904 for enabling the user to discuss the visualization. Additionally, the user interface may also include a GUI element 906 enabling the user to provide further report on the KPI. Further, a user may be provided with a ‘news-feed’ style of analytical data through which the user may not only view the analytical data, but the social commentary to the data within the user's network. A user's network may be tied to a particular group of users and the business with which the business analytical data is associated.

Further, for each KPI, the platform may enable a user to perform actions, including, but not limited to, for example:

1. ‘Like,’ where a user may be able to flag a specific KPI to show that he or she endorses or appreciates. Other users within the network may be able to view the “Like”. Such liking may incentivize users to continue the performance that received the “Like”. Conversely, users may change performance where ‘Likes’ were not received, or even when a like is received, the “Like” of their particular performance is below a superior “Like”.

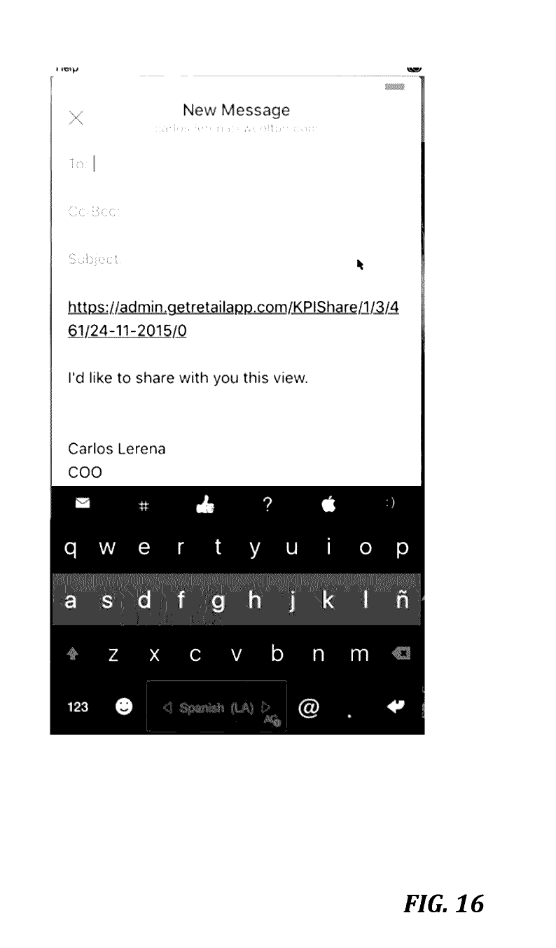

2. ‘Share,’ a user may be able to send a KPI to another user to inform the other user of the specific KPI. For instance, the share may be performed using an internal or external message application system like: SMS, Message, eMail, Twitter, Facebook, Linkedin, Whatsapp, Gmail, Outlook or any other message app to be created. In some embodiments, when the KPI is shared with a recipient, the recipient may only receive a link to the KPI and no confidential information may be provided to the recipient. For instance, as illustrated in FIG. 16, the recipient may receive the link via an email. Accordingly, upon activating the link, the recipient may be presented with the dashboard of the KPI. However, in case the recipient does not have sufficient privileges to view the KPI, the recipient may not be presented with the KPI upon activating the link.

3. ‘Report,’ where a user may send a detailed report regarding a specific KPI. The report may add other information that wasn't displayed in the visualization of the platform. Additionally, the report also could be specific to a specified date. Further, in some embodiments, a user may share a report other users. For example, the report in the form of a PDF file containing the KPIs presented in the metrics may be shared with one or more users. Additionally, in some embodiments, the report may be shared with any user independent of the user's role.

4. Further, users may ‘Comment’ on KPIs. Such ‘Commenting’ may enable users to discuss specific KPIs and relevant information surrounding the specific KPIs. Further, users may ‘Re-Post’ in order to share the ‘Comments’ with other users. Users may have access to certain information granted or denied, depending on their role.

The roles may be arranged in a hierarchy. For example, a hierarchy may include Global, Region, Country, District and Store. Users may be arranged by the associated hierarchy, such as, for example a CEO, a plurality of Regional Directors below the CEO, a plurality of Store Manages below the Regional Directors, and a plurality of Sales Representatives below the Store Managers. The CEO may, for example, “Like” a KPI of a specific Region. The Regional Director of that specific Region as well as associated Store Managers and Sales Representatives may be able to see that the KPI was ‘Liked’. Conversely, the Regional Directors, Store Managers and Sales Representatives not associated with the specific Region may be unable to view the ‘Liked’ KPI. Further, in some embodiments, a “Like” may be shared only with certain regions and/or levels within the hierarchy of the business organization. For instance, the “Likes” provided by a CEO on business analytical data associated with Latin America may not be shared with users in Europe.

KPIs may be displayed in a format such that the most important entities that produce the KPI displayed are highlighted. For example, the top 15 Stores and bottom 10 Stores may be displayed. The highlighted Stores may be displayed on a split screen that is separately scrollable (e.g., a user may be able to scroll through one list of Stores while keeping the other list static).

Embodiments of the present disclosure may provide a streamlined user experience for on-the-job use. The embodiments may provide contextual awareness of the retail environment. Embodiments may be designed to eliminate burdens of system integration and provide for rapid deployment of the system.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

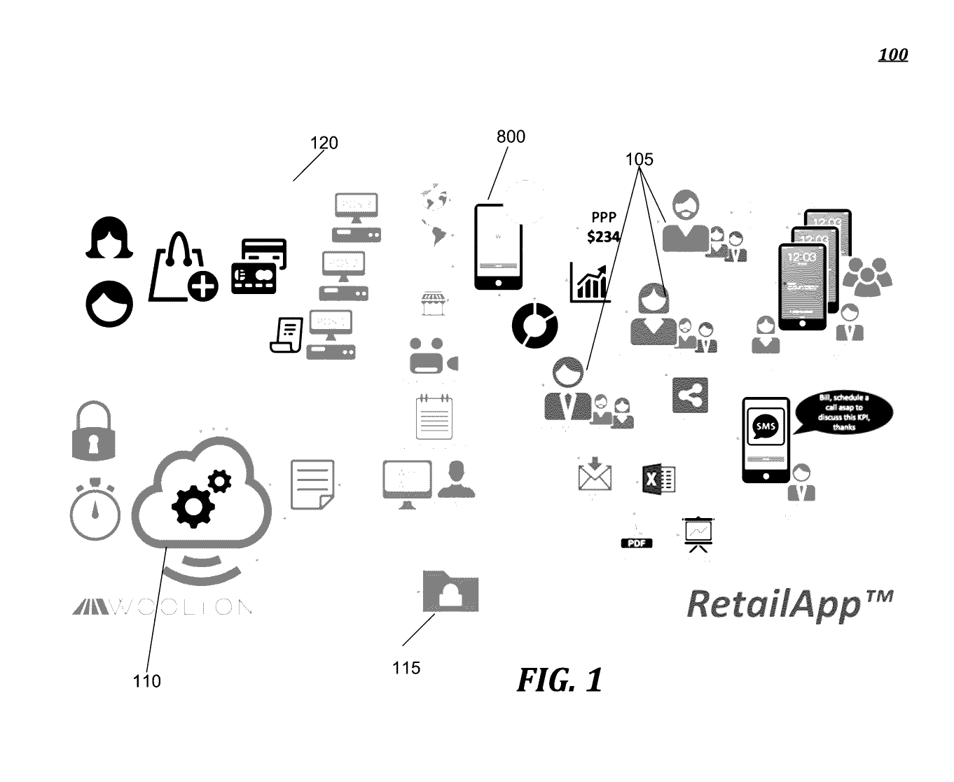

FIG. 1 illustrates one possible operating environment through which a platform consistent with embodiments of the present disclosure may be provided. By way of non-limiting example, platform 100 may be hosted on a centralized server 110, such as, for example, a cloud computing service. A data warehouse 115 may be integrated into the centralized server or hosted on a separate server, such as, for example Microsoft® Azure. A user 105 may access platform 100 through a software application. The software application may be embodied as, for example, but not be limited to, a website, a web application, a desktop application, and a mobile application compatible with a computing device 1400. One possible embodiment of the software application may be provided by the Woolton™ suite of products and services provided by Woolton Inc. A customer 120 may interface with the platform, for example, through a point of sale device at a retail location or via online purchasing. Further, data sources may be received, tracked, and recorded in a plurality other ways. Further, the users 105 could also answer questions, upload forms, forecast a KPI, etc. in addition to consuming information from the platform. In other words, the users 105 may also be the source of data and information to the BI platform. For example, but not limited to, crude oil from a well may be tracked and recorded with applicable sensor technology; customer service records may be logged from online interfacing; and accountants may manually input financial information through an interface program.

Data may be compiled from the plurality of sources into the platform, such as, for example, on centralized server 110 or data warehouse 115. Then, the platform may be configured to perform data analysis. The results of the analyzed data may then be distributed to users via, for example, the software application. Additionally, user devices may be configured to allow users to upload data such as reports to the BI platform.

As will be detailed with reference to FIG. 14 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

### III. Platform Operation

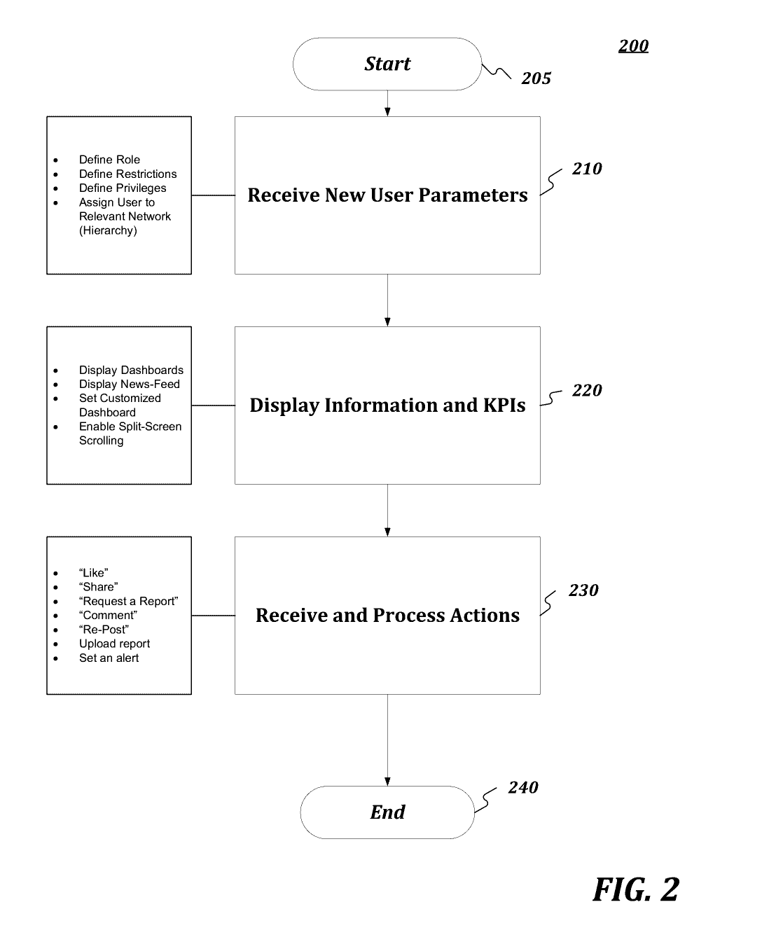

FIG. 2 is a flow chart setting forth the general stages involved in a method 200 consistent with an embodiment of the disclosure for providing platform 100. Method 200 may be implemented using a computing device 1400 as described in more detail below with respect to FIG. 14.

Although method 200 has been described to be performed by platform 100, it should be understood that computing device 1400 may be used to perform the various stages of method 200. Furthermore, in some embodiments, different operations may be performed by different networked elements in operative communication with computing device 1400. For example, server 110 may be employed in the performance of some or all of the stages in method 200. Moreover, server 110 may be configured much like computing device 1400. The server may be a part of, for example, comprise cloud computing platform.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

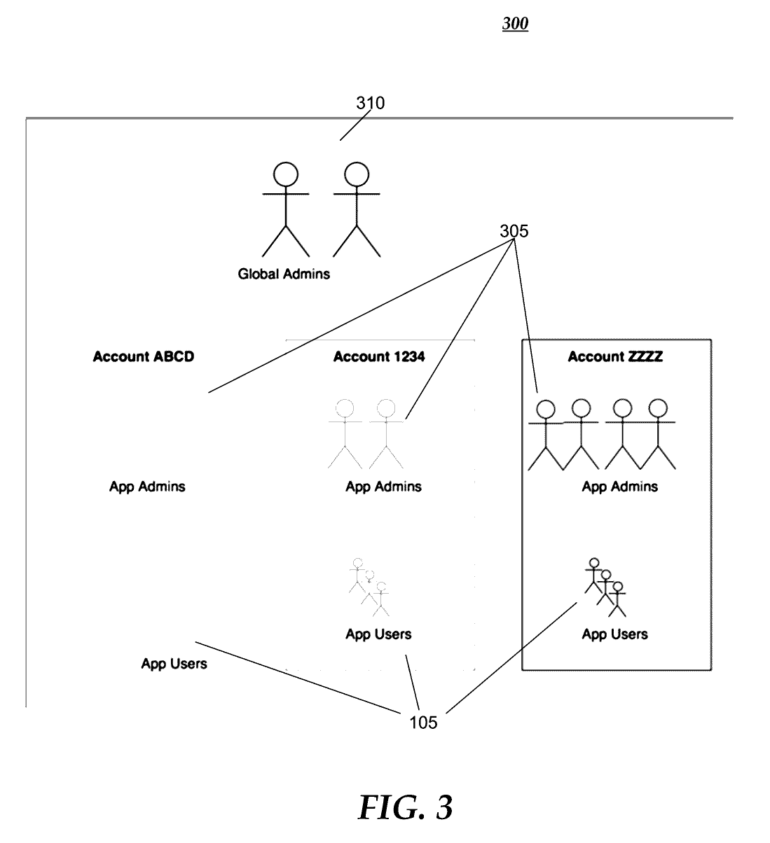

Method 200 may begin at starting block 205 and proceed to stage 210 where platform 100 may receive new user parameters for creating a user account. An app administrator may be in charge of creating, editing and deleting users accessing the application. FIG. 3 illustrates an app administrator hierarchy. The platform may provide such app administrators 305 with some or all access to the app itself and the underlying information. The platform may provide Global app administrators 310 with the ability to assign rights to app administrators 305.

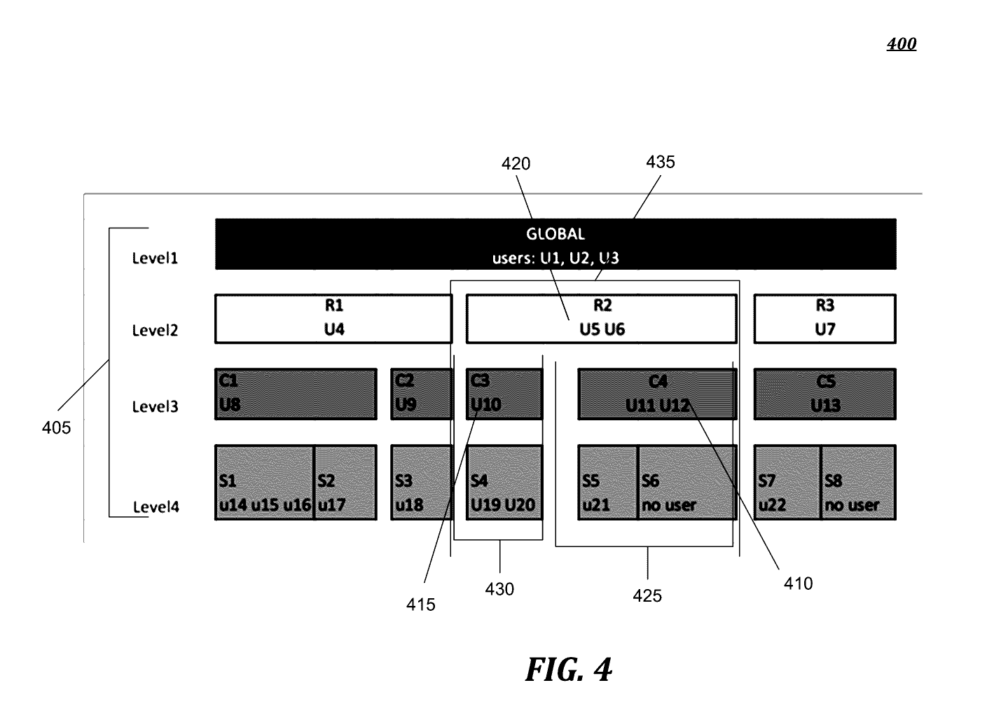

The added user may be associated with a level within a hierarchy, such as, for example, a Global, Region, Country, District or Store. FIG. 4 illustrates a hierarchy of levels 405 into which users may fall. For example, district manager 410 may be associated with district 425, district manager 215 may be associated with district 430, and regional manager 420 may be associated with region 435. Further, district 420 may be within region 425. The level of the user may be associated with the functionality that the platform provides to and restricts from such user. For example, communication, such as liking or sharing, may be limited to others within or below a user's level. Therefore, district manager 410 may be able to see the ‘Likes’ and shares of regional manager 420 corresponding to district 425, but district manager 415 would not be able to see the ‘Likes’ and shares corresponding to district 425.

The user may be further associated with a role within the level. The role of the user may be associated with the functionality that the platform provides to and restricts from such user. In this way, a business CEO may be provided with a first set of platform functionality while a Store Manager may be provided with a second set of platform functionality. In various embodiments, the first set of functionality provided to the ‘CEO’ may encompass the second set of functionality provided to a ‘Store Manager’, thereby establishing a hierarchal access system to the BI platform. Further, it may be noted that the hierarchy may not only determine user access, but may also show the organization view in a company. For instance, one company could have two different hierarchy views: 1—Geographical view. Global, Regions, Countries, Areas, Stores and staff view. 2—Channel View: Global, Distribution, Regions, Countries, Areas, Stores and Staff.

From stage 210, where platform 100 receives new user parameters, method 200 may advance to stage 220 where platform 100 may display information to users. Such information may be analyzed data Stores or other levels (Regions, Countries, Districts, or others that may be added) may be displayed in a format such that the most important Stores are highlighted. For example, Stores may be displayed in a split screen, where top Stores 505 are shown on top and low Stores 510 are show below. For example, the top 15 Stores and bottom 10 Stores may be displayed. Further, the top Stores 505 may be scrolled through independently of the bottom Stores 510, and vice versa.

In various embodiments, the data may be displayed to users in several ways. For example, the user may be provided with charts and graphs that illustrate relevant KPIs to the users. The dashboards may be preset or customized. In addition, the user may be provided with the raw data illustrated by the charts and graphs. Further, a user may be provided with a ‘news-feed’ style of analytical data through which the user may not only view the analytical data, but the social commentary to the data within the user's network.

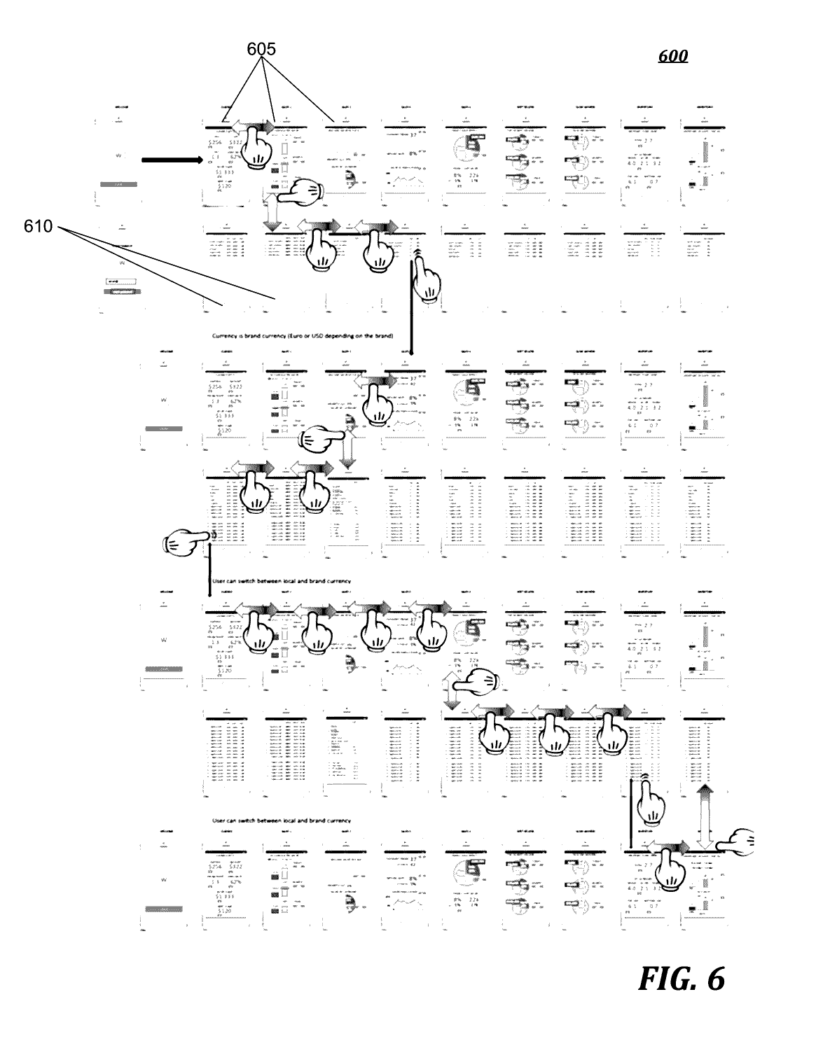

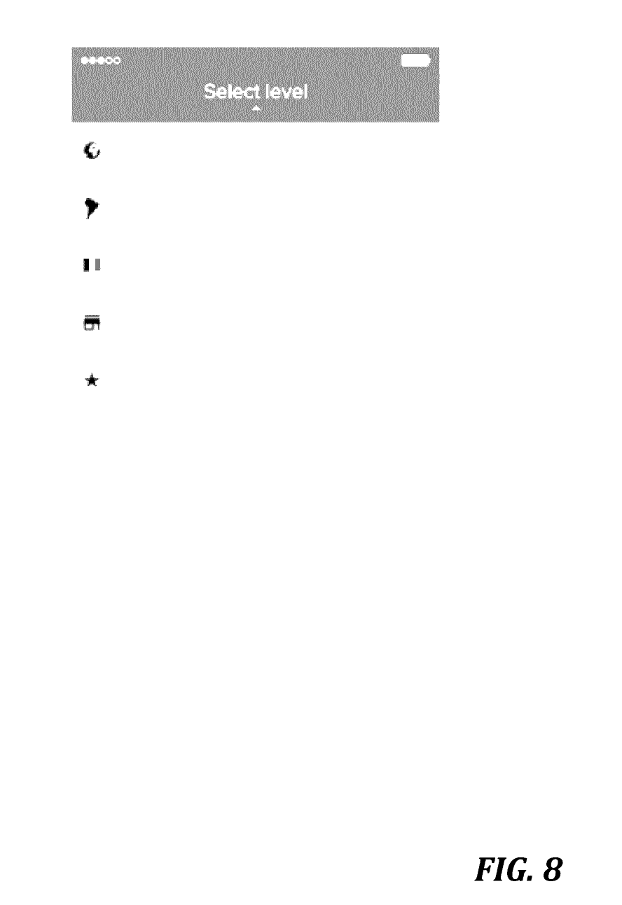

FIG. 6 illustrates how data may be displayed and how data a user may transition between various displays. For example, preset or customized dashboards 605 may be displayed. Such dashboards may display KPIs for the respective dashboard level. In order to switch between dashboards, a user may be able to swipe from right to left. When the platform receives a left or right swipe, the platform may display the next dashboard. The user may be able to rearrange the placement of each dashboard. In that way the user orders the way that he/she wants to see the dashboard. By receiving a first down-swipe, the platform may display a screen that shows how the previous dashboard is being built and ranked by certain criteria defined by the organization (e.g. Sales, conversion rate (‘CV’), etc.) and showing the different regions presented on the corresponding numerical dashboard 610. In some embodiments, by receiving second down-swipe the platform may display the dashboard for the lower hierarchical level. Conversely, upon receiving a first up-swipe, the platform may transition between levels. Upon receiving a second up-swipe the platform may transition from displaying the ranking of entities (e.g., Regions, Countries, Districts or Stores) of a dashboard to showing the dashboard. Users may be able to swipe between any levels to which they have access by swiping up and down. Alternative methods for navigation may exist, such as for example, selecting a region or dashboard from a menu. For instance, as illustrated in FIG. 8, the user interface may be configured to present a list view of the various levels such as, Global, Regional, Countries and Stores. Accordingly, a user may be able to conveniently select a level and view visualizations of analytical data, such as KPIs, associated with the level. In additional, in some instances, the list view may also include a Favorites option to display a list of visualizations of KPIs previously marked as favorites by the user.

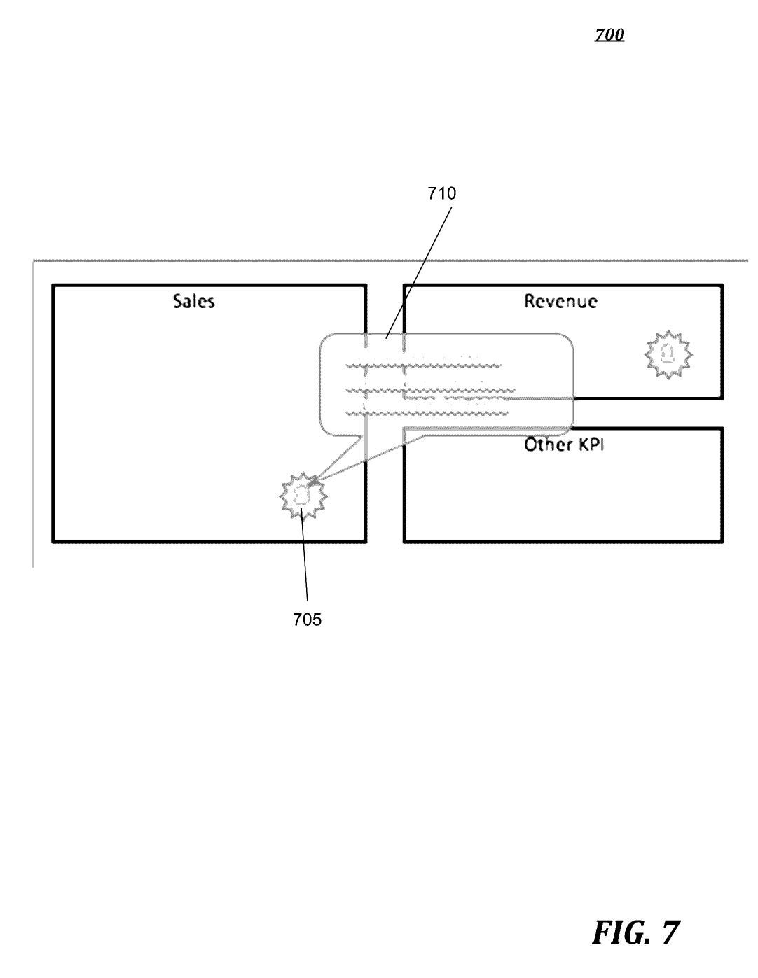

In some embodiments, the KPIs may be displayed in a plurality of colors. Such colors may illustrate a range in which each KPI may lie. For example, the KPIs may be displayed in white, red and green. Such coloring may show the user whether each KPI is above, below or within in range of the benchmark, budget, or any other method of comparison defined with the owner of the network. Once platform 100 displays information to users in stage 220, method 200 may continue to stage 230 where platform 100 may receive and process actions. For example, a user may “Like”, ‘share’, and ‘request a report’. Platform 100 may restrict a user to ‘Liking’ only KPIs to which he or she has access. FIG. 7 illustrates an embodiment of how KPI ‘Likes’ may be displayed. When platform 100 receives a request to “Like”, the platform may display the “Like” so that other users with access may be able to see how many times a KPI was ‘Liked’ 705 as well as who ‘Liked’ the KPI 710. Platform 100 may further notify users associated with the ‘Liked’ KPI. Such notification may display the name of the ‘Liker’, the explanation of the KPI and entity name associated with the ‘Liked’ KPI.

For instance, as illustrated in FIG. 9, the user interface may provide a “Like” button 902 to enable the user to express a “Like” on the KPI displayed in the user interface. Accordingly, “Likes” may be received and aggregated in order to be presented to relevant users.

Further, when platform 100 receives a request to ‘share’ a KPI, platform 100 may send a notification, for example, via SMS or other messaging system, to the user to whom the KPI was ‘shared’. Such notification may include the KPI as well as associated information (e.g. location, level, etc.).

A user may choose to request a report based on data shown on a dashboard of the application. When platform 100 receives a request for a report, platform 100 may send, for example by email, a message. Platform 100 may generate and send an email comprised of a subject describing the report, a message with the same or similar graph as displayed by the application, and an attachment of the raw data stored, for example, as a .csv file. Other relevant data may be included in the message, such as, for example, benchmarks for the KPI. Additionally, in some embodiments, a user may proactively upload data such as reports corresponding to a business analytical data.

Furthermore, the user may be enabled to set an alert on a KPI by specifying a trigger condition. The trigger condition may be for example, “If the KPI falls below X” where X may be a numerical value. Accordingly, the KPI may be regularly monitored and when the KPI value falls below X, an alert may be transmitted to the user through a communication mode such as, but not limited to, SMS, email and/or instant message.

Once platform receives and processes an action in stage 230, method 200 may then end at stage 240.

Further in some embodiments, the platform 100 may be configured to enable users to perform one or more actions on a visualization of business analytical data, such as KPIs. Accordingly, the user interface may be configured to receive a user input, such as for example a touch input, representing the one or more actions as exemplarily described in conjunction with FIG. 9. Further, the one or more actions may include one or more of promoting, discussing, sharing, reporting, requesting a report and a setting an alert.

Additionally, the user interface may be further configured to display data corresponding to the one or more actions. Such data may represent the interaction of users with the visualization of the business analytical data and may be referred to as interaction data. Accordingly, the data corresponding to the one or more actions may be displayed to one or more first users of the plurality of users, whereas the one or more actions may be received from one or more second users of the plurality of users. In other words, interaction data generated by a user may be presented to other users. Further, in some embodiments, by aggregating interaction data and presenting to users, a community-view of the business analytical data may be provided.

Furthermore, in some embodiments, the display of the interaction data to the one or more first users may be based on one or more of a level of the business analytical data associated with the visualization and a role associated with the one or more first users. For instance, an interaction performed by a CEO on a KPI designated as “Global level” may be displayed to all users within a business organization. However, an interaction performed by the CEO on a KPI designed as “District level” may be displayed only to users associated with business units falling under the district. Additionally, users may be able to view interaction data based on associated roles. For instance, interaction data corresponding to “District level” KPIs may not be displayed to users designated as “staff members”. However, users within the district designated as “Store Managers” may be allowed to view the interaction data associated with “District level” KPIs.

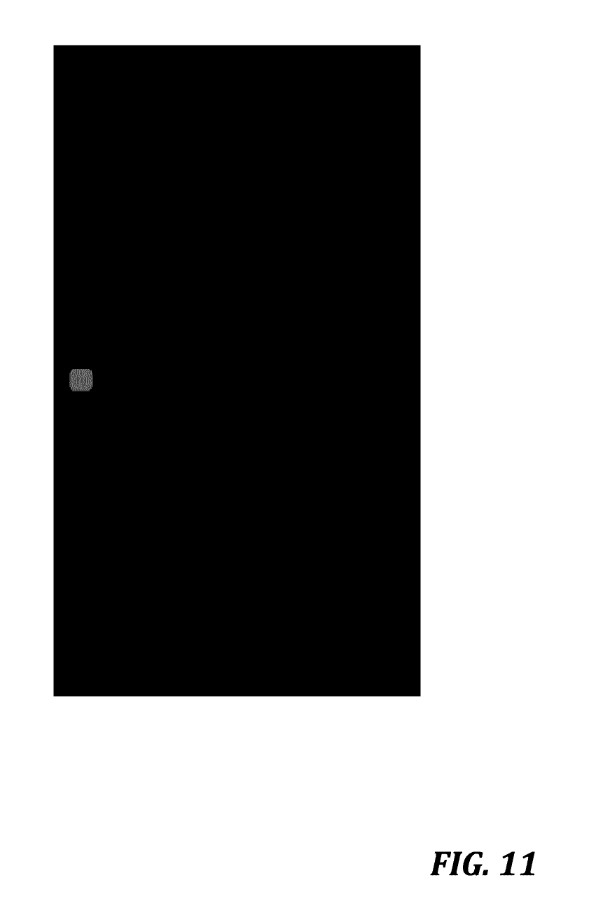

Further, in some embodiments, the user interface may be further configured to display a notification to a user based on receipt of the one or more actions. For example, the notification may be transmitted to the user in the form of SMS, email and/or instant message. For instance, as illustrated in FIG. 11, the notification sent to the user may indicate that another user named “John Doe” has performed a “Like” operation on the KPI “PPP” associated with a level “International”. Further, in some embodiments, the notification may include a link to the visualization corresponding to the one or more actions. Accordingly, the user may activate the link in order to view the visualization of the business analytical data, such as the KPI “PPP”.

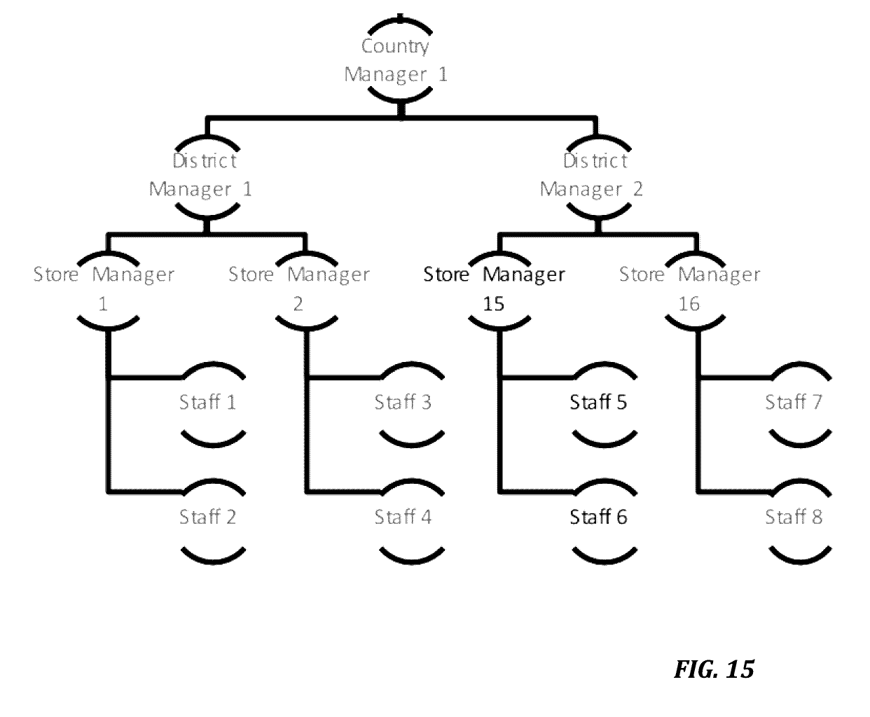

Additionally, in some embodiments, the platform 100 may be configured to selectively propagate notifications to relevant users. For instance, in some embodiments, the display of the notification may be based further on one or more of a level of business analytical data associated with the visualization and a role associated with the user. For instance, referring to FIG. 15, the notification of a “Like” performed by “Country Manager 1” on a KPI designated as “District level” may be transmitted to all users within the business organization. However, the notification of a “Like” performed by “Country Manager 1” on a KPI designed as “Store level” may be displayed only to users associated with a store.

Accordingly, only users related to a store such as “Store Manager 1”, “Staff 1” and “Staff 2” may be selected for transmitting the notification.

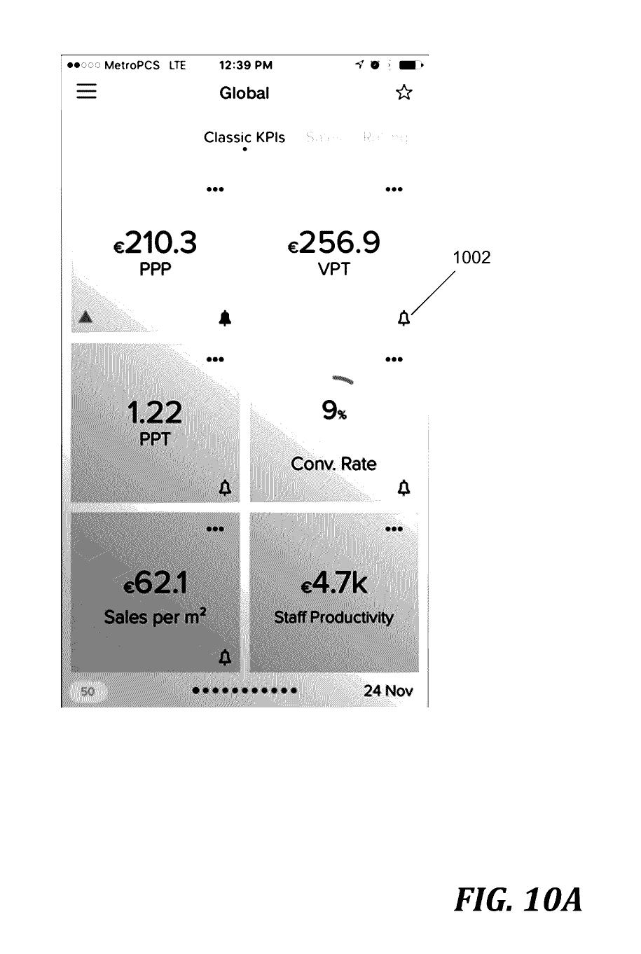

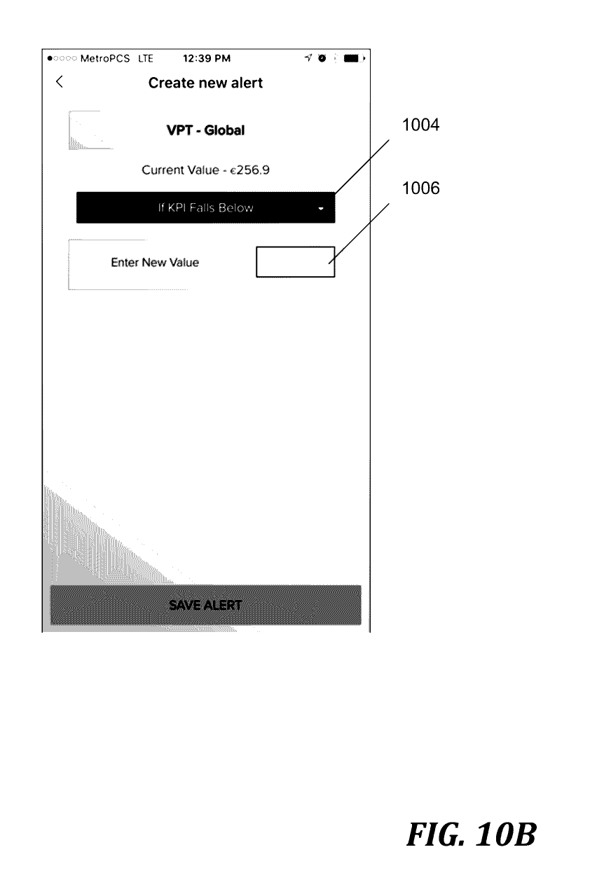

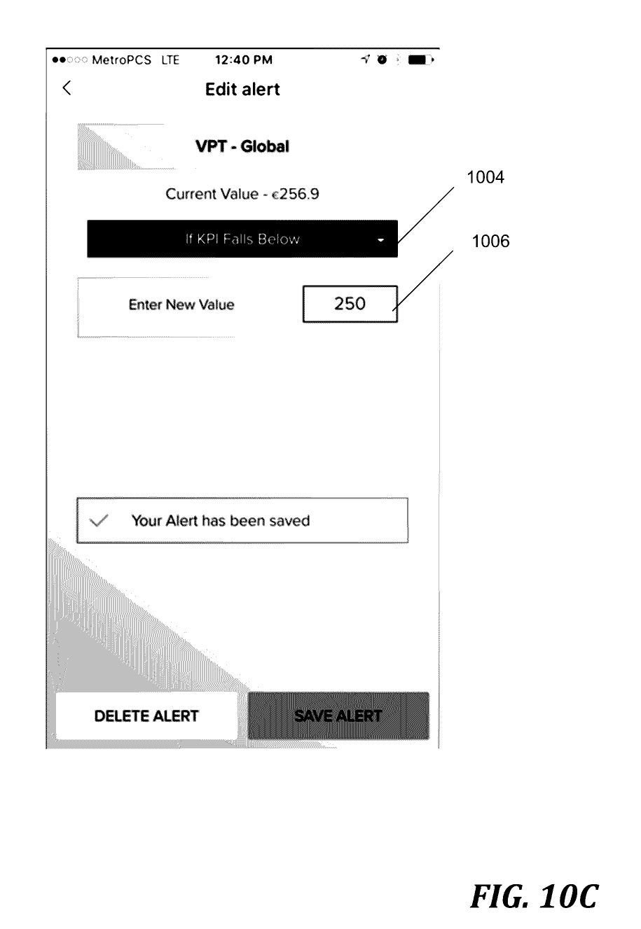

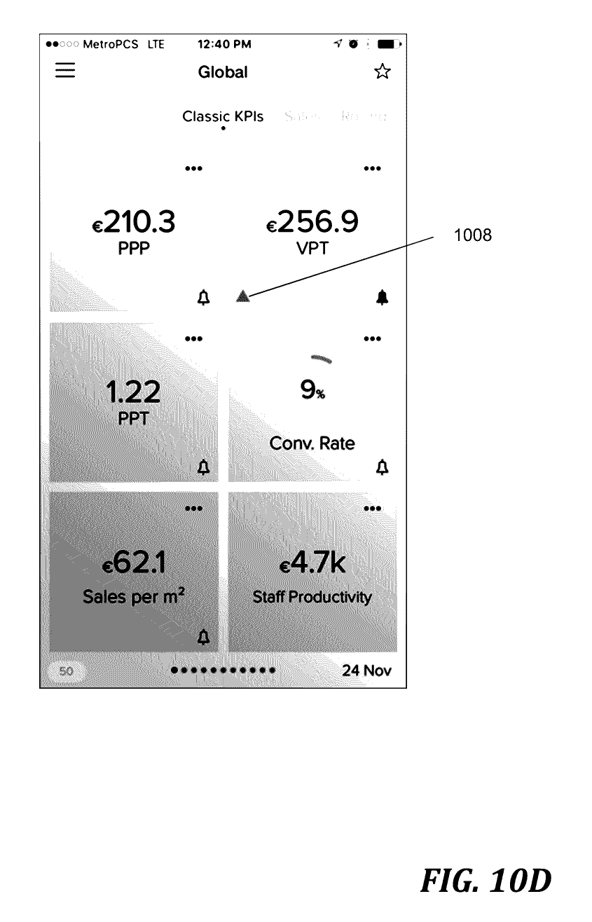

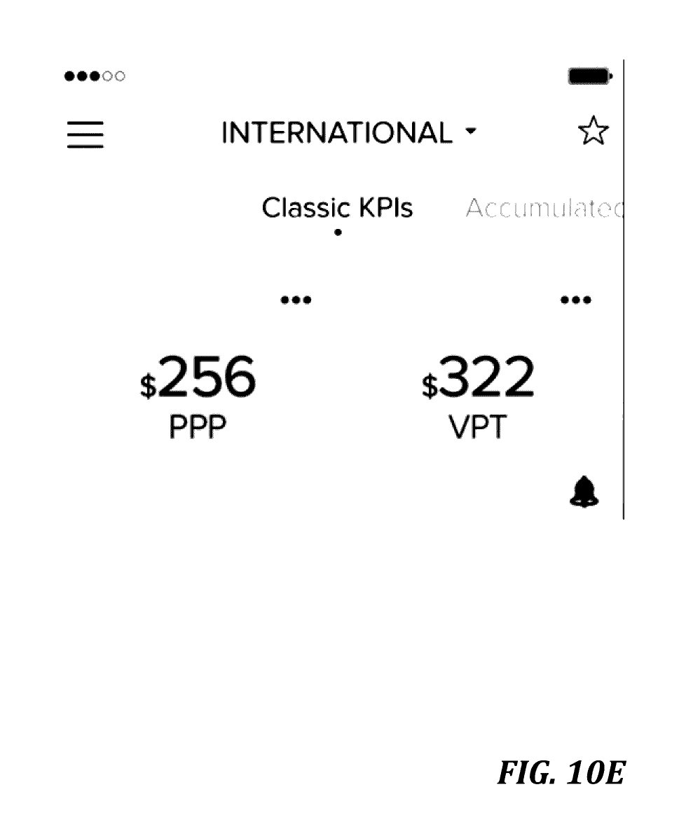

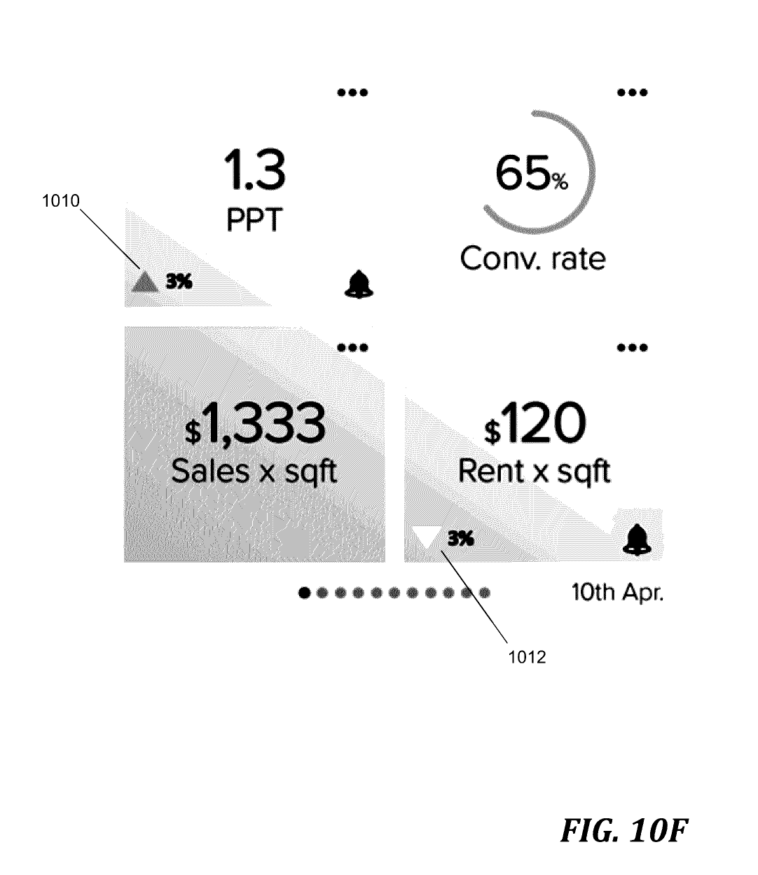

Further, in some embodiments, users of the platform 100 may be enabled to set alerts on business analytical data of interest. For instance, the user interface may be configured to display a GUI element, such as an icon, with each KPI displayed to the user. As an example, as illustrated in FIG. 10A, a GUI element 1002 in the form of a bell shaped icon may be displayed along with a KPI such as “VPT”. Further, GUI element 1002 may include an indication of whether the user has previously set an alert with the KPI. For instance, the bell shaped icon may be “unfilled” to indicate that no alert is currently set on the KPI “VPT”. Accordingly, the user may provide a touch input on the GUI element 1002 to set the alert. Subsequently, the user may be presented with the user interface as depicted in FIG. 10B. As illustrated, the user interface may further include GUI element 1004 configured to specify a trigger condition such as “If KPI falls below” or “If KPI rises above”. The trigger conditions may be presented to the user in the form of a drop down menu as shown. Further, the user interface may include a GUI element 1006 such as a text box, for receiving one or more of a lower limit and an upper limit. As shown, a text box may be specified for receiving a single numerical value. Further, in conjunction with the setting provided by the user in GUI element 1004, the trigger condition for the alert may be specified as exemplarily illustrated in FIG. 10C. Alternatively, in embodiments where the user may be interested to receive alert when the KPI goes outside a range of numerical values, the user may specify each of the lower limit and the upper limit.

Accordingly, the user interface may be further configured perform a comparison of a business analytical data, such as current KPI value, with one or more of the lower limit and the upper limit. Further, based on a result of the comparison, the user interface may be configured to display the notification to the user. Further, in some embodiments, the user interface may be configured to provide an indication of receipt of an alert to the user. For example, as illustrated in FIG. 10D, a GUI element 1008 included in the user interface, such as a triangular icon may be used to indicate receipt of an alert.

Furthermore, in accordance with some embodiments, the user interface may include a spotlight feature which may indicate various scenarios with regard to setting the alert and/or receipt of the alert. For instance, as illustrated in FIG. 10E, when no alert is set or triggered, the user interface may be displayed as shown with no visual indicia. However, in a scenario in which the alert is set but is not triggered, a GUI element 1010 in the form of an upward pointing green triangle may be displayed as illustrated in FIG. 10F. Further, in a scenario in which the alert is set and is triggered, a GUI element 1012 in the form of a downward pointing red triangle may be displayed as illustrated. Accordingly, a user may be able to readily realize a state of the alert.

Further, in some embodiments, the platform 100 may be configured to provide indication of entities associated with the business analytical data to users. Accordingly, the user interface may be further configured to display indication of one or more entities associated with a plurality of business analytical data, such as KPIs. The one or more entities may be for example, an individual such as staff member and/or a business unit such as a store, a district, a state, a country, a region and world.

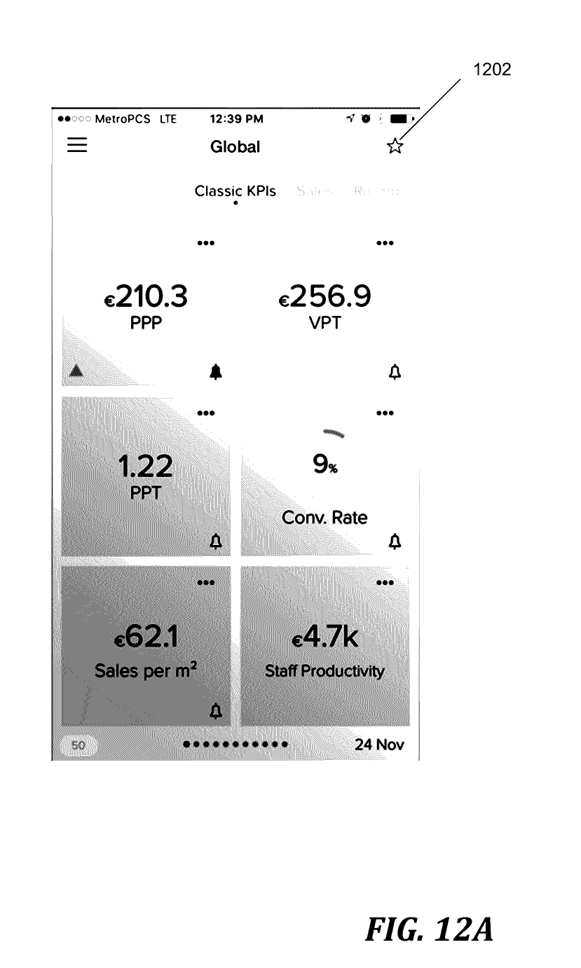

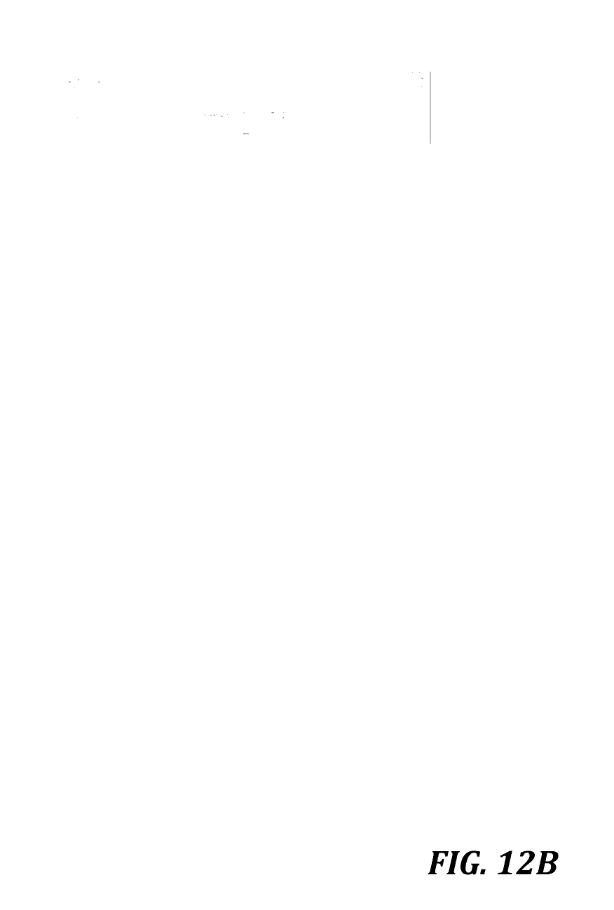

Additionally, in some embodiments, the platform 100 may be configured to enable users to mark a visualization of a KPI and/or an associated entity as a favorite. Accordingly, the user interface may be further configured to receive an input from a user to include indication of the one or more entities and/or associated KPIs to a list of favorites. For instance, as illustrated in FIG. 12A, the user interface may include a GUI element 1202 in the form of a star icon for receiving the input for marking the visualization as a favorite. As shown, the visualization titled “Global” may be marked as favorite by the user. Accordingly, the list of favorites, as exemplarily illustrated in FIG. 12B may be updated with indication of the visualization marked as favorite.

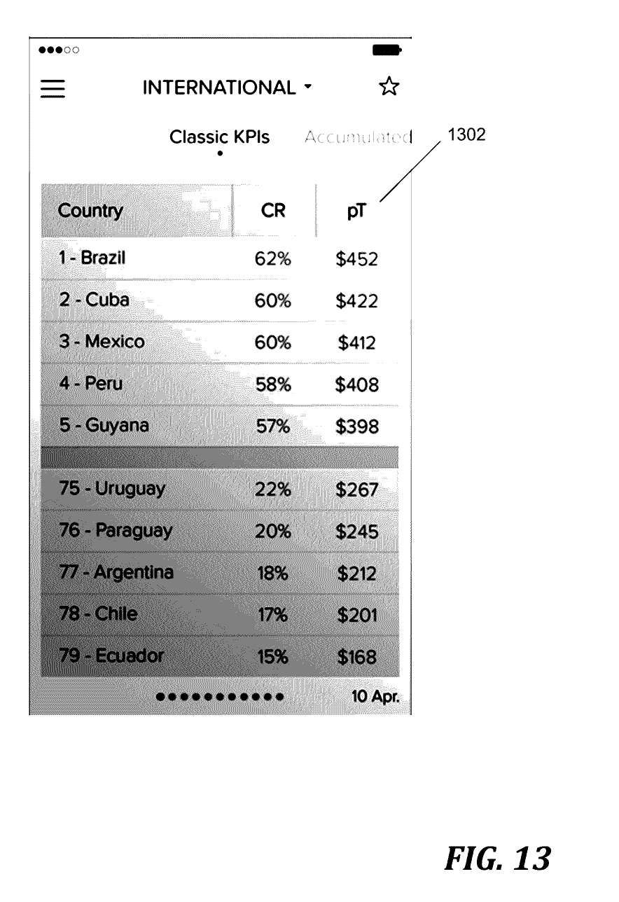

Additionally, in some embodiments, the platform 100 may be configured to display business analytical data in the form of tables. For instance, as illustrated in FIG. 13, each of the indication of a plurality of entities and corresponding plurality of KPIs may be displayed in a table. Further, the user interface may be configured to receive a touch input from the user for sorting entries of the table according to values of one or more KPIs included in the table. For example, as illustrated, the user interface may include GUI element 1302 for receiving a touch input. Further, based on the touch input, entries of the table may be sorted according to values of KPI “pT”. As a result, users may be able to conveniently view the most significant entities contributing to the KPIs.

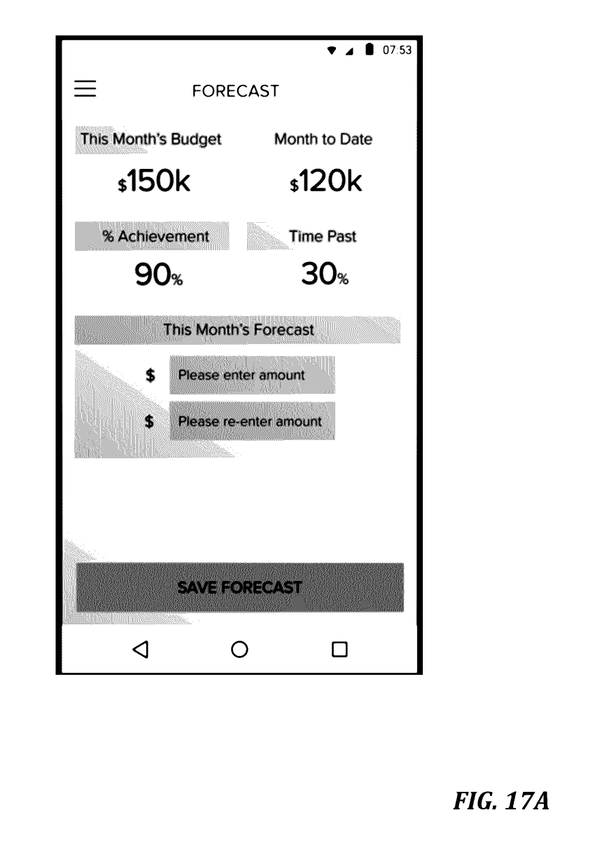

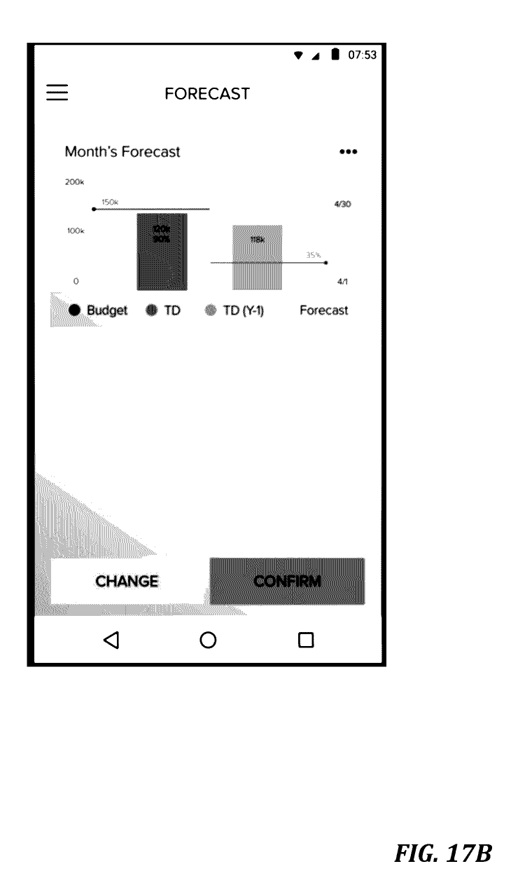

Further, the platform 100 may provide bi-directional Business Intelligence Communications that may enable a user of a higher level (e.g., region directors) to send surveys down to users at lower levels (e.g. store managers) in order to get quick feedback on certain metrics. Additionally, in some instances, instead of sending surveys, users may send forecasts. For example, certain users may have access to and specify forecasting data for the business organization. For instance, FIG. 17A illustrates one such exemplary user interface screen for receiving forecasting data that may be shared with users. Furthermore, users receiving the forecast data from a higher level in the hierarchy may further transmit the forecasting data to other users at lower levels down the hierarchy. Accordingly, when users associated with the lower levels log in next time, the forecasting data may be displayed on their screen, such as exemplarily illustrated in FIG. 17B.

Further, in accordance with some embodiments, a flow chart of a method for receiving forecast data from a user is disclosed. At step 1802, the user may open or re-open an app configured to display the user interface as described herein. The method then proceeds to step 1804, where a check is performed whether forecast data has already been entered for a store. If the result of the check is positive, then the method may terminate. However, if the result of the check is negative, then the method may proceed to step 1806 where a check may be performed to determine if a current date is later than or equal to the 15^{th} of the current month. If the result of the check is negative, then the method may terminate. However, if the current date is later than or equal to the 15^{th} of the current month, the method proceeds to step 1808 where a check is performed to determine whether the user is authorized to provide the forecast data. If the user is not authorized to provide the forecast data, the method may terminate. However, if the user is authorized, the method may proceed to step 1810 where the user is requested to enter the forecast data. Accordingly, the user may be presented with an interface exemplarily illustrated in FIG. 17A to receive the forecast data. Thereafter, the method may proceed to step 1812, where a check is performed to determine whether the user has entered the forecast data. If the result of the check is negative, then at step 1814 the user may not be allowed to skip the step of entering the forecast data. For instance, the user may be displayed a message prompting to enter the forecast data. On the other hand, if the user has entered the forecast data, the method may proceed to step 1816 where the user may return to the app and perform any other usual behavior. Subsequently, the forecast data may be shared with other users down the hierarchy in relation to the user.

### IV. Platform Architecture

The platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, platform 100 may be hosted on a centralized server, such as, for example, a cloud computing service. Although method 200 has been described to be performed by a computing device 1400, it should be understood that, in some embodiments, different operations may be performed by different networked elements in operative communication with computing device 1400.

Embodiments of the present disclosure may comprise a system having a memory storage and a processing unit. The processing unit coupled to the memory storage, wherein the processing unit is configured to perform the stages of method 200.

In accordance with some embodiments, the present disclosure provides a system for provisioning business intelligence to a plurality of users in a business organization. In some instances, the plurality of business analytical data may include a plurality of KPIs. The system may include a storage configured to store a plurality of business analytical data. The business analytical data may correspond to a level of a plurality of levels in the business organization. The plurality of levels may include two or more of global, regional, country, state, district, store and staff.

Further, the system may include a processing unit configured to generate a user interface. The user interface may include a plurality of visualizations of the plurality of business analytical data, such as the KPIs.

In order to provide business intelligence to relevant users, the user interface may be configured such that a functionality associated with the user interface displayed to a user may be based on a role associated with the user. For instance, users designated as “Managers” may be provided with a functionality to upload reports while users designated as “Staff members” may only be able to view reports without being provided an option to upload reports.

Further, a visualization of the plurality of visualizations corresponding to a user may be based on a role associated with the user. For instance, a user may be provided with only certain KPIs depending on the role of the user.

Furthermore, the user interface may be configured to provide an intuitive way of navigating the plurality of business analytical data. Accordingly, the user interface may be configured to receive one or more touch inputs from the user, such as but not limited to, one of more of a horizontal swipe and a vertical swipe.

Further, based on the one or more touch inputs, the user interface may be configured to transition between a first visualization and a second visualization. For instance, the first visualization may be based on a business analytical data corresponding to a first level of the plurality of levels. Further, the second visualization may be based on the business analytical data corresponding to a second level of the plurality of levels. For example, the first visualization may indicate KPIs associated with “Store level” while the second visualization may indicate KPIs associated with “District level”. Accordingly, a user may provide touch input in the form of a vertical swipe to move up or down the organizational hierarchy and view associated KPIs.

Furthermore, in some embodiments, based on the one or more touch inputs, the user interface may be configured to transition between a first visualization of a first business analytical data and a second visualization of a second business analytical data. For instance, the plurality of visualizations may correspond to different KPIs arranged as horizontally scrollable screens. Each screen may include visualization of one set of KPIs. Accordingly, a user may provide a touch input, such as a horizontal swipe input to move across the screens to view different KPIs. Further, in some embodiments, the user interface may be further configured to allow the user to customize the ordering of the horizontally scrollable screens. Accordingly, the user interface may be configured to receive an input from the user to customize an order of the plurality of visualizations.

Furthermore, in some embodiments, the user interface may be configured to enabled to provide social networking features. Accordingly, the user interface may be further configured to receive one or more actions corresponding to a portion of a visualization from one or more users of the plurality of users. For instance, the one or more actions may include one or more of promoting, discussing, sharing, reporting, requesting a report and a setting an alert.

Further, in some embodiment, the user interface may be further configured to display data corresponding to the one or more actions. The data corresponding to the one or more actions may be displayed to one or more first users of the plurality of users, whereas the one or more actions may be received from one or more second users of the plurality of users. Further, the display of the data to the one or more first users may be based on at least one of a level of business analytical data associated with the visualization and a role associated with the at least one first user.

Additionally, in some embodiments, the user interface may be further configured to display a notification to a user based on receipt of the one or more actions. In some instances, the display of the notification may be based further on one or more of a level of business analytical data associated with the visualization and a role associated with the user.

Further, in some embodiments, an action of setting the alert may include specifying one or more of a lower limit and an upper limit. Furthermore, the user interface may be further configured to display the notification based on a result of comparison of a business analytical data with one or more of the lower limit and the upper limit. Additionally, in some embodiments, the notification may include a link to the visualization corresponding to the one or more actions.

Further, in some embodiments, the user interface may be further configured to display indication of one or more entities associated with the plurality of KPIs. Additionally, the user interface may be further configured receive an input from a user to include indication of the one or more entities to a list of favorites.

Furthermore, in some embodiments, each of the indication of a plurality of entities and corresponding plurality of KPIs may be displayed in a table. Additionally, the user interface may be further configured to display the plurality of KPIs in a sorted order based on a touch input received from a user.

Moreover, the system may include a communication connection configured to perform communication with a plurality of user devices associated with the plurality of users. Further, the communication may include the user interface. Accordingly, the plurality of devices may be configured to display the user interface. As a result, the plurality of users may be able to view the plurality of visualizations of the plurality of business analytical data.

FIG. 14 is a block diagram of a system including computing device 1400. Consistent with an embodiment of the disclosure, the aforementioned memory storage and processing unit may be implemented in a computing device, such as computing device 1400 of FIG. 14. Any suitable combination of hardware, software, or firmware may be used to implement the memory storage and processing unit. For example, the memory storage and processing unit may be implemented with computing device 1400 or any of other computing devices 1418, in combination with computing device 1400. The aforementioned system, device, and processors are examples and other systems, devices, and processors may comprise the aforementioned memory storage and processing unit, consistent with embodiments of the disclosure.

With reference to FIG. 14, a system consistent with an embodiment of the disclosure may include a computing device, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400's operation. In one embodiment, programming modules 1406 may include formatting and displaying information to the user, enabling scrolling, and formulating and transmitting messages. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and nonvolatile, removable and non-removable media implemented in any method or technology for storage of information, such as computer readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., scrolling enablement application 1420) may perform processes including, for example, one or more of method 100′s stages as described above. The aforementioned process is an example, and processing unit 1402 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the “Like”. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method of provisioning business intelligence to a plurality of users in a business organization, the method comprising:
creating a plurality of user accounts corresponding to the plurality of users;
assigning a role to each user of the plurality of users;
displaying a user interface to a user of the plurality of users based on a role assigned to the user, wherein the user interface comprises:
a representation of a hierarchy of the business organization, wherein the hierarchy comprises a plurality of levels;
a plurality of dashboards corresponding to the plurality of levels, wherein each dashboard comprises at least one Key Performance Indicator (KPI), wherein the user interface is configured to receive a user input from the user, wherein the user input enables the user to navigate through the plurality of dashboards.
providing a functionality associated with the user interface to the user, wherein the functionality enables the user to perform at least one action, wherein the functionality is based on the role assigned to the user; and
displaying, to at least one other user, interaction data associated with the at least one action performed by the user, wherein the displaying is based on the role assigned to the at least one other user.

2. The method of claim 1, wherein the user input is directed to at least one of the representation of the hierarchy and the plurality of dashboards.

3. The method of claim 2, wherein the user interface is configured to transition between displaying a first dashboard corresponding to a first level and displaying a second dashboard corresponding to a second level, wherein the transition is based on the user input.

4. The method of claim 2, wherein the user interface is configured to transition between displaying a first dashboard comprising the at least one KPI associated with a plurality of entities and displaying a second dashboard comprising a ranking of the plurality of entities, wherein the ranking is based on values of the at least one KPI associated with the plurality of entities.

5. The method of claim 2, wherein the plurality of levels comprises at least two of global, regional, country, state, district, store and staff.

6. The method of claim 2, further comprising receiving a report from at least one user of the plurality of users, wherein the report comprises business analytical data corresponding to the at least one KPI.

7. The method of claim 2, wherein the at least one action comprises at least one of promoting, discussing, sharing, uploading a report, requesting a report and a setting an alert.

8. The method of claim 1, wherein the user interface is further configured to display a notification to a user based on receipt of the at least one action, wherein the display of the notification is further based on at least one of a level of business analytical data associated with a dashboard and a role assigned to the user.

9. The method of claim 7, wherein setting the alert comprises specifying at least one of a lower limit and an upper limit, wherein the user interface is further configured to display the notification based on a result of comparison of a business analytical data associated with a dashboard with at least one of the lower limit and the upper limit.

10. The method of claim 2 further comprising aggregating the interaction data corresponding to the plurality of users, wherein the user interface is configured to display a community view of the interaction data based on the aggregating.

11. A computer-readable medium having computer-executable instructions stored thereon which, when executed by a computer, will cause the computer to:
create a plurality of user accounts corresponding to a plurality of users;
assign a role to each user of the plurality of users;
display a user interface to a user of the plurality of users based on a role assigned to the user, wherein the user interface comprises:
a representation of a hierarchy of a business organization, wherein the hierarchy comprises a plurality of levels;
a plurality of dashboards corresponding to the plurality of levels, wherein each dashboard comprises at least one Key Performance Indicator (KPI), wherein the user interface is configured to receive a user input from the user, wherein the user input enables the user to navigate through the plurality of dashboards.
provide a functionality associated with the user interface to the user, wherein the functionality enables the user to perform at least one action, wherein the functionality is based on the role assigned to the user; and
display interaction data corresponding to the functionality to a user, wherein the displaying is based on the role assigned to the user.

12. A system for provisioning business intelligence to a plurality of users in a business organization, the system comprising:
a storage configured to store a plurality of business analytical data, wherein a business analytical data corresponds to a level of a plurality of levels in the business organization;
a processing unit configured to generate a user interface comprising a plurality of visualizations of the plurality of business analytical data; and
a communication connection configured to perform communication with a plurality of user devices associated with a plurality of users, wherein the communication comprises the user interface, wherein the plurality of devices are configured to display the user interface.

13. The system of claim 31, wherein the plurality of business analytical data comprises a plurality of Key Performance Indicators (KPIs).

14. The system of claim 31, wherein a functionality associated with the user interface displayed to a user is based on a role associated with the user.

15. The system of claim 31, wherein a visualization of the plurality of visualizations corresponding to a user is based on a role associated with the user.

16. The system of claim 31, wherein the plurality of levels comprises at least two of global, regional, country, state, district, store and staff.

17. The system of claim 31, wherein the user interface is further configured to receive at least one action corresponding to at least a portion of a visualization from at least one user of the plurality of users.

18. The system of claim 41, wherein the at least one action comprises at least one of promoting, discussing, sharing, reporting, requesting a report and a setting an alert.

19. The system of claim 41, wherein the user interface is further configured to display data corresponding to the at least one action, wherein the data corresponding to the at least one action is displayed to at least one first user of the plurality of users, wherein the at least one action is received from at least one second user of the plurality of users, wherein the display of the data to the at least one first user is based on at least one of a level of business analytical data associated with the visualization and a role associated with the at least one first user.

20. The system of claim 32, wherein the user interface is further configured to display indication of at least one entity associated with the plurality of KPIs.
